(19) United States
(12) Patent Application Publication
(10) Pub. No.: US 2017/0102087 A1
(43) Pub. Date: Apr. 13, 2017

(54) Control Assembly for a Valve

(71) Applicant: TESCOM CORPORATION, Elk River, MN (US)

(72) Inventors: Eric J. Burgett, McKinney, TX (US); Zhang Yingchun, Shanghai (CN)

(73) Assignee: TESCOM CORPORATION, Elk River, MN (US)

(21) Appl. No.: 15/187,316

(22) Filed: Jun. 20, 2016

(30) Foreign Application Priority Data
Oct. 12, 2015 (CN) 201510658531.4
Oct. 12, 2015 (CN) 201520790365.9

(51) Int. Cl. F16K 27/02; F16K 31/122; F16K 1/12

(52) U.S. Cl. CPC F16K 27/0254; F16K 1/126; F16K 31/1221

(57) ABSTRACT

A control assembly for a valve includes a stem displaceable relative to a body portion of the valve from a closed position in which a valve portion of the stem portion engages a valve seat portion to an open position in which the valve portion is offset from the valve seat portion. A portion of the stem portion is movably disposed within the flow orifice. The control assembly further includes a connector portion, and a connector bore is formed in a bottom surface of the connector portion. A first end of the stem portion is disposed within the connecter bore of the connector portion.

### FIELD OF THE DISCLOSURE

This disclosure relates generally to valves, and more particularly, to a control assembly for a valve.

### BACKGROUND

Pressure regulating valves are used in a variety of industrial and residential applications for controlling the downstream pressure of a fluid. In some applications, the regulator valve includes a control assembly that includes an elongated connector portion and an elongated stem portion. The connector portion is adapted to be longitudinally displaced by an actuator, such as a piston, contacting a top end of the connector portion. Typically, a bottom portion of the connector portion includes a reduced diameter portion (having a diameter of 0.9 mm, for example) that extends through a flow orifice (having a diameter of 1.5 mm, for example) of a valve seat. A bottom surface of the reduced diameter portion contacts a top surface of a stem portion, the top surface of the stem portion is adjacent to a valve portion of the stem portion that engages and disengages the valve seat (to close and open the valve) when the connector moves up or down. While the abutment of the bottom surface of the reduced diameter portion of the connector portion and the top surface of the stem portion works well for low and intermediate inlet flow pressures (e.g., 10 k-15 k psi), failure of or damage to the relatively thin bottom portion of the connector member may occur at higher inlet pressures (e.g., 20 k psi), resulting in possible buckling of the bottom portion of the connector portion. Such failure or buckling may lead to leakage through the valve seat and, at least, an inconvenient and costly replacement of the control assembly.

### BRIEF SUMMARY OF THE DISCLOSURE

A regulator valve includes a body portion and an inlet and an outlet are defined in the body portion. The regulator valve 10 also includes a valve seat portion disposed within the body portion between the inlet and the outlet, and the valve seat portion includes an engagement surface. A flow orifice extends through the valve seat portion. The regulator valve also includes an elongated stem portion disposed within a main bore of the body portion. The stem portion extends along a stem axis from a first end to a second end, and the stem portion includes a valve portion disposed between the first end and the second end. The stem portion is displaceable relative to the body portion along the stem axis from a closed position in which the valve portion engages the engagement surface of the valve seat portion to an open position in which the valve portion is offset along the stem axis from the engagement surface of the valve seat portion thereby allowing fluid to flow from the inlet to the outlet. A portion of the stem portion is movably disposed within the flow orifice. The regulator valve further includes an elongated connector portion disposed within the main bore of the body portion. The connector portion extends along a connector axis from a first end to a second end. A connector bore is formed in a bottom surface disposed at the second end of the connector portion, and the first end of the stem portion is disposed within the connecter bore of the connector portion. The connector portion is displaceable relative to the body portion along the connector axis from a first position in which the stem portion is in the closed position to a second position in which the stem portion is in the open position.

### BRIEF DESCRIPTION OF THE DRAWINGS

FIG. 1 is a cross-sectional view of an embodiment of a regulator valve including an embodiment of a control assembly;

FIG. 2 is a more detailed cross-sectional view of the embodiment of the regulator of FIG. 1;

FIG. 3 is a cross-sectional view of an embodiment of the control assembly with a stem portion in a closed position;

FIG. 4 is a partial cross-sectional view of an embodiment of the control assembly with the stem portion in an open position;

FIG. 5 is a side view of an embodiment of a stem portion; and

FIG. 6 is a partial cross-sectional view of an embodiment of the stem portion and the connector portion.

### DETAILED DESCRIPTION

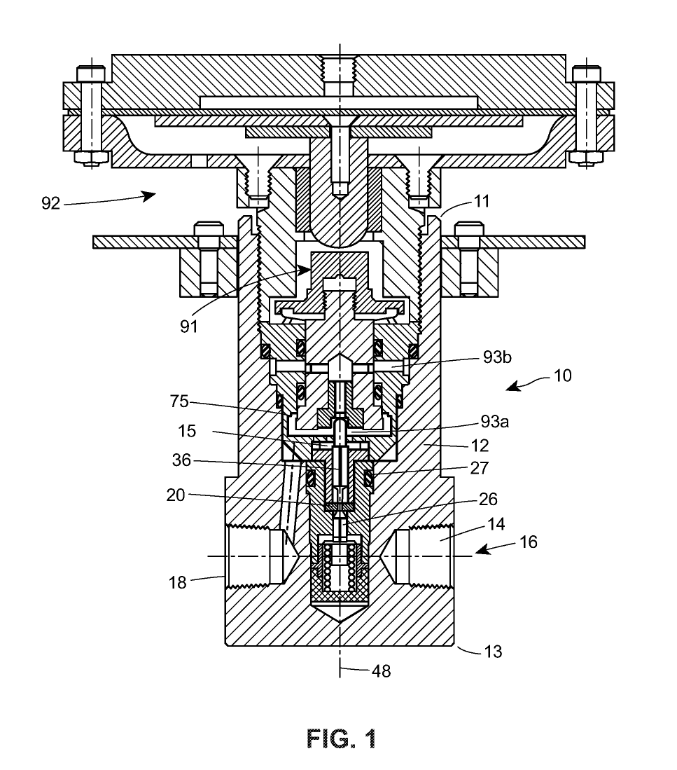

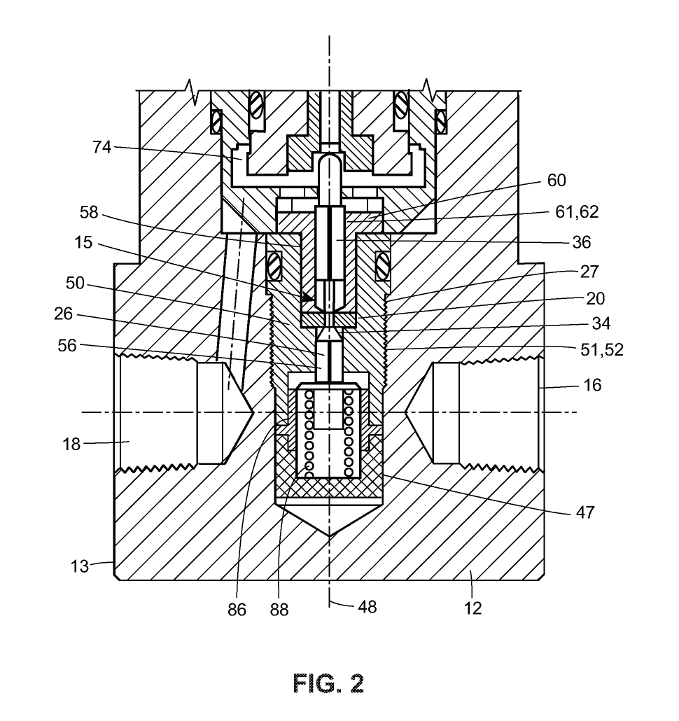

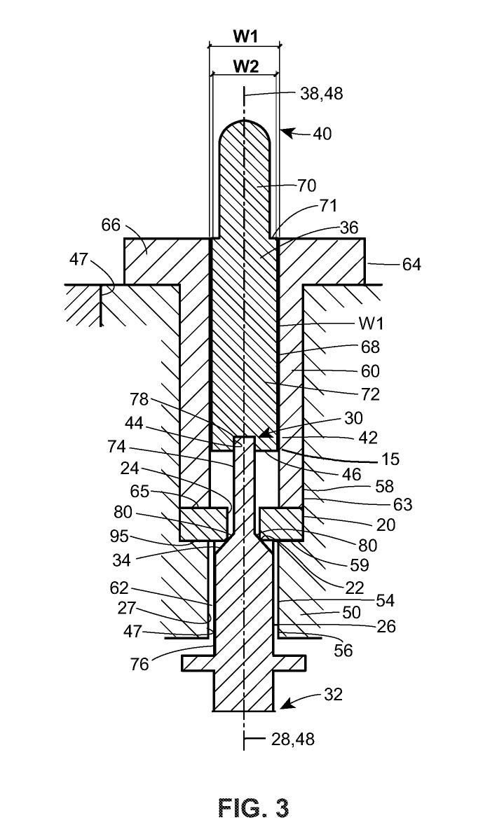

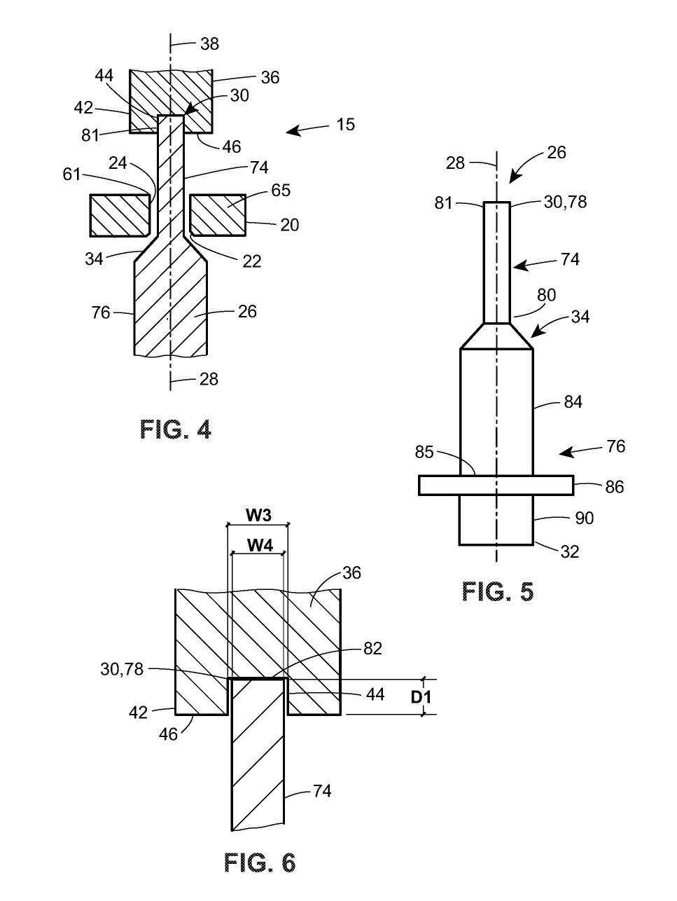

As illustrated in FIG. 1, a regulator valve 10 includes a body portion 12 and an inlet 16 and an outlet 18 are defined in the body portion 12. The regulator valve 10 also includes a valve seat portion 20 disposed within the body portion 12 between the inlet 16 and the outlet 18, and as illustrated in FIG. 2, the valve seat portion 20 includes an engagement surface 22. A flow orifice 24 extends through the valve seat portion 20. As illustrated in FIG. 1, the regulator valve 10 also includes a control assembly 15 that includes an elongated stem portion 26 disposed within a main bore 27 of the body portion 12. Referring to FIG. 3, the stem portion 26 extends along a stem axis 28 from a first end 30 to a second end 32, and the stem portion 26 includes a valve portion 34 disposed between the first end 30 and the second end 32. The stem portion 26 is displaceable relative to the body portion 12 along the stem axis 28 from a closed position (illustrated in FIG. 3) in which the valve portion 34 engages the engagement surface 22 of the valve seat portion 20 to an open position (illustrated in FIG. 4) in which the valve portion 34 is offset along the stem axis 28 from the engagement surface 22 of the valve seat portion 20 thereby allowing fluid to flow from the inlet 16 to the outlet 18 through the flow orifice 24. The shape of the engagement surface 22 and an outer surface of the valve portion 34 may be complimentary, and the engagement surface 22 and the outer surface of the valve portion 34 may both be conical or frusto-conical in shape. A portion of the stem portion 26 is movably disposed within the flow orifice 24.

As illustrated in FIG. 1, the control assembly 15 further includes an elongated connector portion 36 disposed within the main bore 27 of the body portion 12. Referring to FIG. 3, the connector portion 36 extends along a connector axis 38 from a first end 40 to a second end 42. A connector bore 44 is formed in a bottom surface 46 disposed at the second end 42 of the connector portion 36, and the first end 42 of the stem portion 26 is disposed within the connecter bore 44 of the connector portion 36. The connector portion 36 is displaceable relative to the body portion 12 along the connector axis 38 from a first position (illustrated in FIG. 3) in which the stem portion 26 is in the closed position to a second position (illustrated in FIG. 4) in which the stem portion 26 is in the open position.

Configured with the first end 30 of the stem portion 26 disposed within the connector bore 44 of the connector portion 36, the control assembly 15 remains stable under high inlet pressure application (e.g., 20 k psi) as well as lower or intermediate inlet pressure applications (e.g., 10-15 k psi).

Turning to the regulator valve 10 in more detail, the body portion 12 may be elongated and may extend along a longitudinal axis 48 from a first end 11 to a second end 13, as illustrated in FIG. 1. With reference to FIG. 2, the inlet 16 and the outlet 18 may be formed as passages through the body portion 12, and the inlet 16 may extend in a direction normal to the longitudinal axis 48 and into a first portion 47 of the main bore 27 that extends along the longitudinal axis 48. A body insert 50 may be disposed in the first portion 47 of the main bore 27, and a threaded portion 51 of the body insert 50 may threadedly engage a threaded portion 52 of the first portion 47 of the main bore 27 such that the body insert 50 is fixed to the body portion 12. An insert bore 54 may extend from a first end of the body insert 50 to a second end of the body insert 50, and the insert bore 54 may be aligned with the longitudinal axis 48. As illustrated in FIG. 3, the insert bore 54 may include a first bore portion 56 and a second bore portion 58, and a diameter or width of the first bore portion 56 may be less than a diameter or width of the second bore portion 58 such that a shoulder 59 is formed at an intermediate point between the first end and the second end. The first bore portion 56 may have a constant cross-sectional shape, such as a polygonal shape, a circular shape, or an oval shape, for example.

As illustrated in FIG. 3, the regulator valve 10 may include a valve seat portion 20 may have a disk-like shape having a bottom surface 95 that rests on a surface of the insert bore 54 forming the shoulder 59. So disposed, the flow orifice 24 may be coaxially aligned with the longitudinal axis 48, and a diameter of the flow orifice 24 may be less than the diameter of each of the first bore portion 56 and the second bore portion 58.

As illustrated in FIG. 3, the regulator valve 10 may also include a retainer 60 may be disposed in the main bore 27, and at least a portion of the retainer may be disposed in the first portion 47 of the main bore 27. The retainer 60 may extend along a central axis from a first end 64 to a second end 63, and the central axis may be aligned with the longitudinal axis 48. The second end 63 may be disposed at or adjacent to a top surface 65 of the valve seat portion 20, and a bottom surface of a flange portion 66 of the retainer 60 (disposed at the first end 64) may be in contact with or adjacent to a portion of the first end of the body insert 50. A cylindrical outer surface of the retainer 60 may be directly adjacent to a surface of the body insert 50 defining the second bore portion 58. A threaded portion 61 of the retainer 60 may threadedly engage a threaded portion 62 of the second bore portion 58 of the body insert 50 such that the retainer 60 is fixed to the body insert 50 (and the body portion 12).

A retainer bore 68 may extend from the first end 64 of the retainer 60 to the second end 63 of the retainer 60, and the retainer bore 64 may extend along the longitudinal axis 48. The retainer bore 68 may have a constant cross-sectional shape (e.g., a polygonal shape, a circular shape, or oval shape) from the first end 64 to a point adjacent to the second end 63. The constant cross-sectional shape may have a width W1 (i.e., a distance normal to the longitudinal axis 48), and the width W1 may be a maximum width. Adjacent to the second end 63, the width decreases from the constant width W1 to a diameter approximately equal to that of the flow orifice 24. The width W1 of the retainer bore 68 may be approximately equal to the diameter of the first bore portion 56 of the insert bore 54.

As previously explained, the control assembly 15 of the regulator valve 10 also includes the elongated connector portion 36 disposed within the main bore 27 of the body portion 12, and at least a portion of the connector portion 36 (i.e., the second end 42) may be disposed within the first portion 47 of the main bore 27. The connector portion 36 may extend along the connector axis 38, and the connector axis 38 may be aligned with the longitudinal axis 48. The connector portion 36 may have an engagement portion 70 and a main portion 72, with the engagement portion 70 extending from the first end 40 to an intermediate point 71 and the main portion 72 extending from the intermediate point 71 to the second end 42. The engagement portion 70 is adapted to be contacted by a component of a valve, such as a piston 75 (see FIG. 1), that applies a force directed along the connector axis 38 towards the second end 42 of the connector portion 36 (i.e., a downward force). The skilled person would recognize that fluid pressure within a cavity 93a (and/or 93b) of the body portion 12 may displace the piston 75, or the piston 75 may be displaced by a portion of an assembly 91 coupled to a diaphragm assembly 92, as illustrated in FIG. 1. Under such a downward force, the connector portion 36 translates along the connector axis 38 towards the second end 13 of the body portion 12 relative to the retainer 60 and the body portion 12.

The main portion 72 of the connector portion 36 may have a constant cross-sectional shape that may generally correspond to the cross-sectional shape of the retainer bore 68. That is, if the retainer bore 68 has a square (or hexagonal) cross-sectional shape, the main portion 72 of the connector portion 36 has a square (or hexagonal) cross-sectional shape. However, a width W2 (e.g., a maximum width W2) of the main portion 72 of the connector portion 36 may be smaller than the width W1 of the retainer bore 68 such that a gap exists between the main portion 72 and the retainer bore 68.

The retainer bore 68 may have a constant cross-sectional shape (e.g., a polygonal shape, a circular shape, or oval shape) from the first end 64 to a point adjacent to the second end 63. The constant cross-sectional shape may have a width W1 (i.e., a distance normal to the longitudinal axis 48). Adjacent to the second end 64, the width decreases from the constant width W1 to a diameter approximately equal to that of the flow orifice 24. The width W1 of the retainer bore 68 may be approximately equal to the diameter of the first bore portion 56 of the insert bore 54. In the first position of the connector portion 36, (illustrated in FIG. 3 in which the stem portion 26 is in the closed position), the intermediate point 71 is adjacent to the second end 64 of the retainer 60. Also in this first position, the second end 42 of the connector portion is 36 offset from the second end 63 of the retainer 60. The connector bore 44 is formed in the bottom surface 46 disposed at the second end 42 of the connector portion 36, and the first end 42 of the stem portion 26 is disposed within the connecter bore 44 of the connector portion 36. The bottom surface 46 may have any suitable shape or combination of shapes to allow the first end 42 of the stem portion 26 to be suitably disposed within the connecter bore 44. For example, the bottom surface 46 may be planar and may be normal to the connector axis 38. In the first position, the bottom surface 46 may be a first longitudinal distance from the top surface 65 of the valve seat portion 20, and in the second position, the bottom surface 46 may be a second longitudinal distance from the top surface 65 of the valve seat portion 20, and the first longitudinal distance may be greater than the second longitudinal distance. The connector bore 44 may have any suitable cross-sectional shape and depth, as will be described in more detail below.

Referring to FIG. 3, the control assembly 15 of the regulator valve 10 further includes the elongated stem portion 26 disposed within the main bore 27 of the body portion 12, and at least a portion of the stem portion 26 (e.g., the entire stem portion 26) may be disposed within the first portion 47 of the main bore 27. The stem portion 26 extends along the stem axis 28 from the first end 30 to the second end 32, and the stem axis 28 may be aligned with the longitudinal axis 48 (and/or the connector axis 38). Referring to FIG. 5, the stem portion 26 may include a mating portion 74, a base portion 76, and the valve portion 34, and the valve portion 34 may be disposed between the mating portion 74 and the base portion 76. The mating portion 74 may extend along the stem axis 28 from a first end 78 (at the first end 30 of the stem portion 26) to a second end 80 (adjacent to a top portion of the valve portion 34). The depth of the connector bore 44 may be a distance that is between 5% and 25% of the length of the mating portion 74.

The mating portion 74 may have an suitable cross-sectional shape and length (along the stem axis 28) to allow the downward displacement of the connector portion 36 from the first position to the second position (as illustrated in FIG. 4) to disengage the valve portion 34 from the engagement surface 22 of the valve seat portion 20. For example, the mating portion 74 may have a constant or substantially constant cross-sectional shape, and the constant cross-sectional shape may generally correspond to that of the connector bore 44 of the connector portion 36. In other embodiments, at least (or only) a top portion 81 (e.g., a portion between—or adapted to be between—the bottom surface 46 of the connector portion 36 and the first end 78 of the mating portion 74) of the mating portion 74 may have a cross-sectional shape that may generally correspond to the cross-sectional shape of the connector bore 44 of the connector portion 36. In some embodiments, the mating portion 74 (or at least the top portion 81) and the connector bore 44 may each have a polygonal shape, a circular shape, or oval shape, for example. As illustrated in FIG. 6, a maximum width W3 (e.g., a maximum diameter, if the cross-sectional shape is circular) of the connector bore 44 is slightly greater (e.g., 3% to 10% greater) than a maximum width W4 (e.g., a maximum diameter, if the cross-sectional shape is circular) of the mating portion 74 (or at least the top portion 81). The maximum width W3 of the connector bore 44 may be a distance that is between 10% and 80% of the width W2 of the connector portion 36.

The connector bore 44 may have any suitable depth to adequately secure the first end 30 of the stem assembly 26, such as, for example, approximately 1 mm. In some embodiments, the depth of the connector bore 44 may be between 10% and 80% of the width W2 of the connector portion 36. A longitudinal distance D1 between the bottom surface 46 of the connector portion 36 and a transverse bore surface 82 (which may be planar or substantially planar, for example) may have any suitable value, such as approximately 1 mm. For example, the longitudinal distance D1 may be approximately equal to the maximum width W3 of the connector bore 44. The skilled person would recognize that when the connector portion 36 downwardly translates along the connector axis 38 (such as, for example, when translated in an know manner by a diaphragm assembly 92 illustrated in FIG. 1), contact between the transverse bore surface 82 and a portion (e.g., a top surface) of the top portion 81 of the stem portion 26 causes the stem portion to translate along the stem axis 28 from the closed position to the open position.

With reference to FIG. 4, the mating portion 74 (or at least a portion of the mating portion 74 that extends through the flow orifice 24 of the valve seat portion 20) may be shaped and dimensioned to be movably received or disposed within the flow orifice 24 of the valve seat portion 20. Moreover, in the open position of the stem portion 26 (illustrated in FIG. 4), the mating portion 74 (or at least a portion of the mating portion 74 that extends through the flow orifice 24 of the valve seat portion 20) may be shaped and dimensioned such that a first gap G1 exists between the surface of the mating portion 74 and the surface defining the flow orifice 24. In this open position, fluid flowing from the inlet 16 to the outlet 18 may flow through first gap G1.

Referring to FIG. 5, the elongated stem portion 26 includes the base portion 76 that extends from a bottom portion of the valve portion 34 to the second end 32 of the stem portion 26. The base portion 76 may include an intermediate portion 84 that may extend between the bottom portion of the valve portion 34 to the an intermediate point 85 disposed between the bottom portion of the valve portion 34 and the second end 32 of the stem portion 26. In some embodiments, the intermediate portion 84 may extend from the bottom portion of the valve portion 34 to the second end 32 of the stem portion 26.

The intermediate portion 84 may have a longitudinal length such that in the open position of the stem portion 26, the intermediate portion 84 may extend to (or beyond) the end of the first bore portion 56 of the insert bore 54 of the body insert 50 (see FIG. 3). The intermediate portion 84 may be shaped and dimensioned to be movably received or disposed within the first bore portion 56, and the cross-sectional shape of the intermediate portion 84 may generally correspond to the cross-sectional shape of the first bore portion 56. In the open position of the stem portion 26 (illustrated in FIG. 4), the intermediate portion 84 may be shaped and dimensioned such that a second gap G2 (see FIG. 3) exists between the surface of the intermediate portion 84 and the surface defining the first bore portion 56. In this open position, fluid flowing from the inlet 16 to the outlet 18 may flow through the second gap G2.

In some embodiments, such as that illustrated in FIG. 5, an annular spring seat 86 may extend around a circumference of the base portion 76 (e.g., a circumference of the base portion 76 between the intermediate portion 84 and the second end 32 of the stem portion 26. As illustrated in FIG. 2, the spring seat 86 may be adapted to contact a portion of a coil spring 88 that may be disposed within the main bore 27 that biases the stem portion 26 into the closed position. Referring again to FIG. 5, the base portion 76 may include an end portion 90 that extends from the spring seat 86 (or, if no spring seat 86 is used, from the intermediate point 85 to the second end 32 of the stem portion 26). The end portion 90 may be cylindrical and may have a diameter less than a diameter of the coil spring 88 and an outer diameter of the spring seat 86.

Configured with the first end 30 of the stem portion 26 disposed within the connector bore 44 of the connector portion 36, the control assembly 15 demonstrates improved stability over conventional control assemblies. That is, a first end 30 of the stem portion 26 disposed within the connector bore 44 of the connector portion 36 provides for a “fixed pin” column style that exhibits improved stability over the “fixed free” end of conventional control assemblies, which is consistent with a column analysis using the Euler Equation. Accordingly, the fixed pin column style disclosed herein remains stable under high inlet pressure application (e.g., 20 k psi) as well as lower or intermediate inlet pressure applications (e.g., 10 k-15 k psi).

While various embodiments have been described above, this disclosure is not intended to be limited thereto. Variations can be made to the disclosed embodiments that are still within the scope of the appended claims.

What is claimed is:

1. A regulator valve comprising:
a body portion having an inlet and an outlet 18 defined in the body portion 12;
a valve seat portion disposed within the body portion between the inlet and the outlet, the valve seat portion including an engagement surface and a flow orifice extending through the valve seat portion;
a control assembly, the control assembly comprising:
an elongated stem portion disposed within a main bore of the body portion, and extending along a stem axis from a first end to a second end, the stem portion including a valve portion disposed between the first end and the second end, the stem portion being displaceable relative to the body portion along the stem axis from a closed position in which the valve portion engages the engagement surface of the valve seat portion to an open position in which the valve portion is offset along the stem axis from the engagement surface of the valve seat portion thereby allowing fluid to flow from the inlet to the outlet through the flow orifice, and wherein a portion of the stem portion is movably disposed within the flow orifice; and
an elongated connector portion disposed at least partially within the main bore of the body portion and extending along a connector axis from a first end to a second end, wherein a connector bore is formed in a bottom surface disposed at the second end of the connector portion, and wherein the first end of the stem portion is disposed within the connecter bore of the connector portion, wherein the connector portion is displaceable relative to the body portion along the connector axis from a first position in which the stem portion is in the closed position to a second position in which the stem portion is in the open position.

2. The regulator valve of claim 1, wherein the stem portion includes a mating portion extending from the valve portion to the first end of the stem portion, the extension portion extending through the flow orifice and having a maximum width that is less than the maximum width of the flow orifice.

3. The regulator valve of claim 1, wherein the mating portion has a circular cross-sectional shape.

4. The regulator valve of claim 2, wherein a maximum width of the mating portion is less than a maximum width of the valve portion.

5. The regulator valve of claim 1, wherein the stem axis and the connector axis are coaxially-aligned.

6. The regulator valve of claim 1, wherein the engagement surface of the valve seat portion has a conical shape.

7. The regulator valve of claim 1, wherein the stem portion includes an annular spring seat disposed between the valve portion and the second end of the stem portion.

8. The regulator valve of claim 1, wherein a retainer is disposed within the main bore of the body portion, and at least a portion of the connector portion is disposed within a retainer bore of the retainer.

9. The regulator valve of claim 1, wherein a depth of the connector bore is approximately equal to a maximum width of the connector bore.

10. A control assembly for a regulator valve, the control assembly comprising:
an elongated stem portion extending along a stem axis from a first end to a second end, the stem portion including a valve portion disposed between the first end and the second end, the stem portion adapted to be displaceable relative to a body portion of the regulator valve along the stem axis from a closed position in which the valve portion engages an engagement surface of a valve seat portion to an open position in which the valve portion is offset along the stem axis from the engagement surface of the valve seat portion thereby allowing fluid to flow from an inlet to an outlet of the regulator valve through a flow orifice of the valve seat portion; and
an elongated connector portion extending along a connector axis from a first end to a second end, wherein a connector bore is formed in a bottom surface disposed at the second end of the connector portion, and wherein the first end of the stem portion is disposed within the connecter bore of the connector portion, wherein the connector portion is adapted to be displaceable relative to the body portion of the regulator valve along the connector axis from a first position in which the stem portion is in the closed position to a second position in which the stem portion is in the open position.

11. The control assembly of claim 10, wherein the stem portion includes a mating portion extending from the valve portion to the first end of the stem portion, the extension portion adapted to extend through the flow orifice and having a maximum width that is less than the maximum width of the flow orifice.

12. The control assembly of claim 11, wherein the mating portion has a circular cross-sectional shape.

13. The control assembly of claim 11, wherein a maximum width of the mating portion is less than a maximum width of the valve portion.

14. The control assembly of claim 10, wherein the stem axis and the connector axis are coaxially-aligned.

15. The control assembly of claim 10, wherein the engagement surface of the valve seat portion has a conical shape.

16. The control assembly of claim 10, wherein the stem portion includes an annular spring seat disposed between the valve portion and the second end of the stem portion.

17. The control assembly of claim 10, wherein a depth of the connector bore is approximately equal to a maximum width of the connector bore.
